(19) United States
(12) Patent Application Publication
(10) Pub. No.: US 2007/0159917 A1
(43) Pub. Date: Jul. 12, 2007

(54) Pivoting handheld food preparation appliance and associated method

(76) Inventors: Brian K. Beesley, Draper, UT (US); Claude R. Brandt, Salt Lake City, UT (US); Eric Hales, Ogden, UT (US)

Correspondence Address: THORPE NORTH & WESTERN, LLP., 8180 SOUTH 700 EAST, SUITE 200, SANDY, UT, 84070, US

(21) Appl. No.: 11/652,138

(22) Filed: Jan. 8, 2007

Related U.S. Application Data
(60) Provisional application No. 60/757,738, filed on Jan. 9, 2006.

(51) Int. Cl. A47J 43/044

(52) U.S. Cl. 366/129

(57) ABSTRACT

A handheld food preparation appliance and a method of selectively preparing food ingredients. The handheld food preparation appliance has a housing including a handle and a chuck. The handle and chuck are pivotally coupled together and have two interconnected orientation configurations with respect to one another, including an aligned configuration in which a longitudinal axis of the handle is substantially aligned with a longitudinal axis of the chuck, and a transverse configuration in which the longitudinal axis of the handle is transverse to the longitudinal axis of the chuck. The handle is configured to be gripped and the chuck is configured to support at least one rotational element. The appliance has a motor carried by the housing. The appliance also has two separate switches associated with the housing and operably coupled to the motor. Each switch is operable with a different orientation configuration of the handle and chuck.

### PRIORITY CLAIM

Priority of U.S. Provisional Patent Application Ser. No. 60/757,738, filed on Jan. 9, 2006, is claimed; and is herein incorporated by reference.

### FIELD OF THE INVENTION

The present invention relates generally to handheld appliances and associated methods for selectively gripping and operating these appliances.

### BACKGROUND OF THE INVENTION

Handheld appliances, such as hand mixers and immersion blenders can be held in one hand and process food ingredients with a variety of implements, such as mixing beaters, whisks, or blades. Such handheld food preparation appliances generally have either a 90 degree handle-to-implement orientation (hand mixer), or a vertically linear handle-to-implement orientation (immersion blender).

A hand mixer with a 90 degree orientation configuration has implements that are substantially perpendicular to the alignment of the handle. This type of handheld kitchen appliance is convenient for preparing food ingredients in a bowl where the appliance can be held above the bowl with the processing implements extending away from the handle and into the bowl, and the handle extending parallel to the horizontal plane of the opening of the bowl. The 90 degree orientation of the handle with respect to the implements provides a comfortable, ergonomic position for the user's hand to hold the handheld kitchen appliance when working with food in a bowl on a countertop surface. However, this 90 degree orientation does not generally accommodate preparing foods that are in a narrow and/or deep container such as a drinking glass since the substantially horizontal handle prevents the appliance from being lowered into the narrow container so that the implement can reach the bottom inner surface of the container and effectively process ingredients therein.

The processing implements of an immersion blender are oriented at approximately 0 or 180 degrees to the handle. Thus, the implements of this type of appliance extend away from the handle along a common longitudinal axis, or “in-line” with the handle. This type of handheld kitchen appliance is convenient for mixing food ingredients in smaller containers, such as mugs or cups. The in-line orientation of the handle with respect to the implements provide for a comfortable, ergonomic position for the hand to hold the handheld kitchen appliance when working in a relatively perpendicular orientation with respect to a countertop surface.

Some kitchen appliances can switch between an in-line orientation and a 90 degree orientation. For example, see the Gizmo™ Twist Blender™ by Black and Decker. However, these appliances have only a single activation switch that can be difficult to reach and awkward to maneuver in either or both orientations.

### SUMMARY OF THE INVENTION

It has been recognized that it would be advantageous to provide a handheld appliance or handheld food preparation appliance with both a beater or mixer configuration (horizontal handle) and a plunge mixer configuration (vertical handle). In addition, it has been recognized that it would be advantageous to provide such an appliance with two switches, each associated with a different configuration of the appliance to facilitate comfortable or ergonomic use.

Accordingly, the present invention provides a handheld appliance comprising a housing including two housing sections pivotally coupled together and having two interconnected orientation configurations with respect to one another. The handheld appliance also comprises a motor carried by the housing, and two separate switches associated with the housing and operably coupled to the motor. Each switch is operable with a different orientation configuration of the sections.

In one aspect, a handheld food preparation appliance is provided. The handheld food preparation appliance includes a housing with a handle and a chuck pivotally coupled together and having two interconnected orientation configurations with respect to one another. One of the orientation configurations is an aligned configuration in which a longitudinal axis of the handle is substantially aligned with a longitudinal axis of the chuck. Another orientation configuration is a transverse configuration in which the longitudinal axis of the handle is transverse to the longitudinal axis of the chuck. In both configurations the handle is configured to be gripped and the chuck is configured to support at least one rotational element. The handheld food preparation appliance also includes a motor carried by the housing, and two separate switches associated with the housing. Both switches are operably coupled to the motor and each switch is operable with a different orientation configuration of the handle and chuck.

In another aspect, a method of selectively preparing food ingredients is provided. The method includes selecting one of at least two configurations of a food preparation appliance. One configuration is an aligned configuration in which a longitudinal axis of a handle is substantially aligned with a longitudinal axis of a chuck. Another configuration is a transverse configuration in which the longitudinal axis of the handle is transverse to the longitudinal axis of the chuck. The method includes orienting the food preparation appliance in a desired configuration, gripping the appliance in a manner associated with the desired configuration, and positioning a rotational element extending from a chuck of the food preparation appliance into a container having ingredients therein. The method further comprises activating one of two separate switches associated with the desired configuration of the food preparation appliance to operate a motor of the appliance coupled to the rotational element, and deactivating a switch to disengage the motor.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a side view of a handheld appliance in accordance with an embodiment of the present invention, shown with the appliance in a transverse orientation configuration;

FIG. 2 is a side view of the handheld appliance of FIG. 1, shown with the appliance in an aligned orientation configuration;

FIG. 3 is cross section view of the handheld appliance of FIG. 1;

FIG. 4 is a perspective view of the handheld appliance of FIG. 1;

FIG. 5 is a bottom view the handheld appliance of FIG. 1;

FIG. 6 is a side view of a handheld food preparation appliance in accordance with one embodiment of the present invention, shown with the handle and chuck in a transverse orientation configuration with respect to each other, and shown with a beater attachment;

FIG. 7 is a side view of the handheld food preparation appliance of FIG. 6, shown with the handle and chuck in an aligned orientation configuration with respect to each other, and shown with a plunge mixer attachment;

FIG. 8 is a side cross section view of the handheld food preparation appliance of FIG. 6;

FIG. 9 is a perspective view of the handheld food preparation appliance of FIG. 6, shown with the handle and chuck in an aligned orientation configuration with respect to each other, and shown with a chopper attachment;

FIG. 10 is a cross section view of the handheld food preparation appliance of FIG. 9;

FIG. 11 is a perspective view of a handheld food preparation appliance in accordance with another embodiment of the present invention, shown with the handle and the chuck in a transverse orientation configuration with respect to each other, and shown with a beater attachment;

FIG. 12 is a perspective view of the handheld food preparation appliance of FIG. 1, shown with the handle and chuck in an aligned orientation configuration with respect to each other, and shown with a plunge mixer attachment;

FIG. 13 is a cross section view of the handheld food preparation appliance of FIG. 11;

FIG. 14 is a cross section view of the handheld food preparation appliance of FIG. 12; and

FIG. 15 is a bottom view of the handheld food preparation appliance of FIG. 11.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

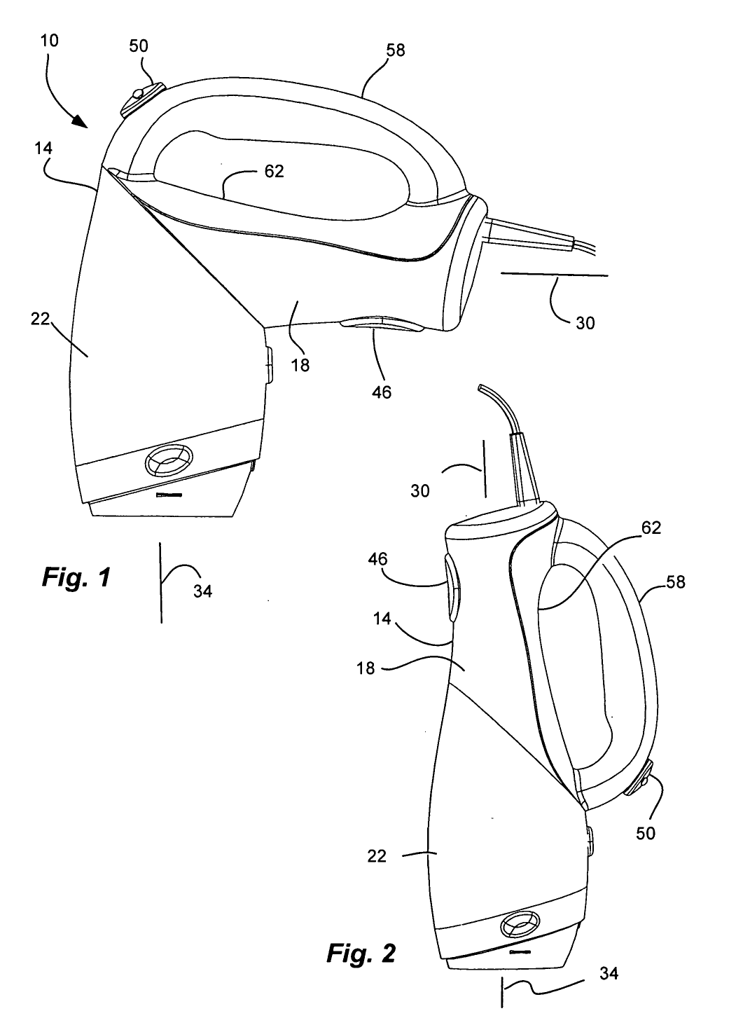

As illustrated in FIGS. 1-5, a handheld appliance, indicated generally at 10, is shown in accordance with an exemplary embodiment of the present invention. Specifically, the appliance 10 is configured as a household food preparation appliance, such as a combination hand mixer and immersion blender.

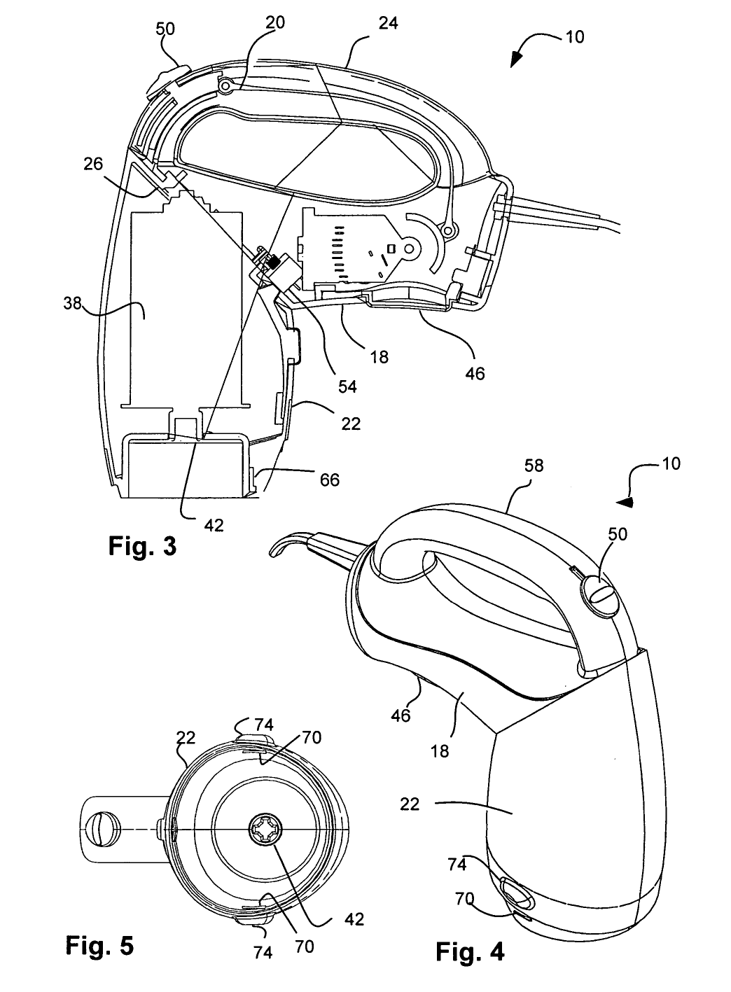

The handheld appliance 10 has a housing 14 with two housing sections, such as a handle 18 and a chuck 22, pivotally coupled together. The handle can be configured to be grasped in a user's hand. The chuck can be configured to receive a rotational element. The housing 14 or housing sections can be formed of plastic and can be a hollow shell. The housing sections or the handle 18 and chuck 22 can be pivotally coupled together at a joint 26. The housing section can pivot between two interconnected orientation configurations with respect to one another. The configurations can include 1) an aligned configuration, as shown in FIG. 2, and 2) a transverse configuration, as shown in FIGS. 1, 3 and 4. In the alignment configuration (FIG. 2), a longitudinal axis 30 of the handle 18 is substantially aligned with a longitudinal axis 34 of the chuck 22. In the transverse configuration (FIGS. 1 and 3), the longitudinal axis 30 of the handle 18 is transverse to the longitudinal axis 34 of the chuck 22. The longitudinal axis 30 of the handle 18 can extend along a length of the handle, or through openings in the user's hand when griping the handle. The longitudinal axis 34 of the chuck 22 can be parallel with a rotational axis as discussed below.

The two housing sections can be coupled together in a variety of fashions. For example, the handle can have a substantially annular track or groove or channel while the chuck can have one or more protrusions that extend into the track and move in the track as the handle and chuck twist. Alternatively, the housing sections can be coupled together by a fastener, such as a screw or bolt that also acts as an axle about which the housing sections can pivot with respect to one another. Alternatively, the housing sections can be coupled together by a ball and socket joint, a substantial ball and socket joint, or a dovetail joint. It is understood that the two housing sections can form a sequence of different angles with respect to each other between the two interconnected orientation configurations.

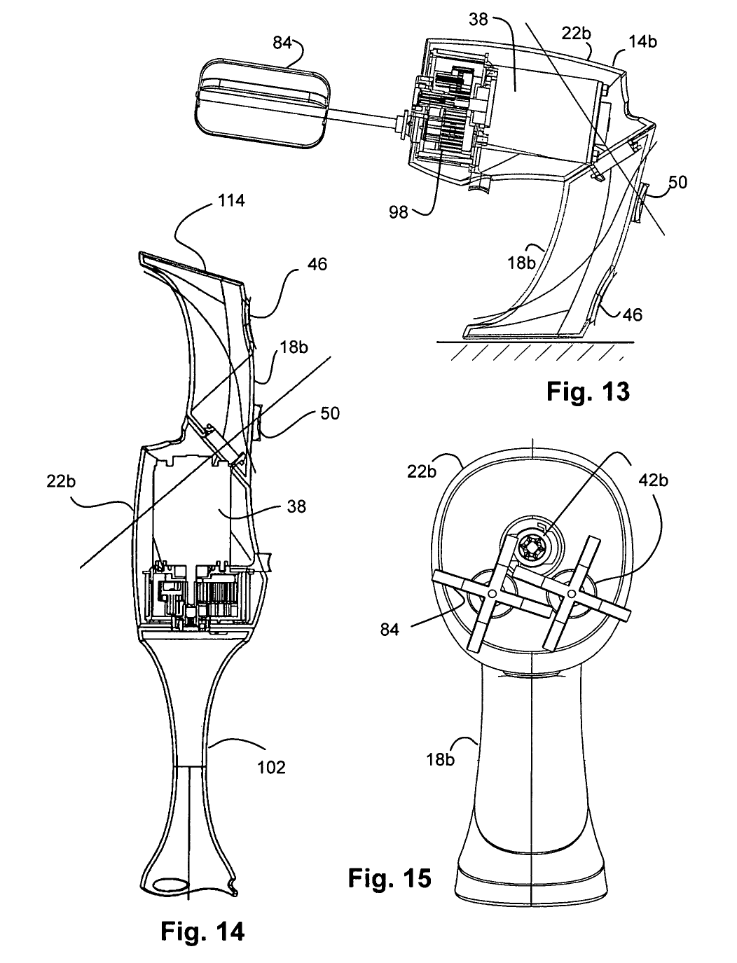

A motor 38 (FIG. 3) can be carried by the housing 14, such as by being disposed in the chuck 22. It is of course understood that the motor could be disposed in the handle. The motor 38 can be an electric motor powered by an electric cord plugged into a standard outlet, and extending through the handle. Alternatively, the motor can be powered by a battery carried by the housing, such as in the housing. The motor can have an output shaft or coupling 42 (FIG. 5) disposed on a distal end of the chuck to receive a rotational element. The output shaft can extend directly to the motor, as shown in FIG. 3, or can have a gear mechanism, as shown in FIG. 13. As described above, the longitudinal axis 34 of the chuck can be parallel with the rotational axis of the motor or output shaft. The motor 38 can be coupled to various rotational implements, including food processing implements such as blenders, whisks, beaters, blades and stirring rods.

Two separate switches 46 and 50 are associated with the housing 14 and operatively coupled to the motor 38. The switches can be electrically coupled between the motor and a power source, such as the electrical cord or a battery. Each switch is operable with a different orientation configuration of the housing sections. For example, one switch 50 can be operable in the transverse orientation, as shown in FIG. 1, while another switch 46 can be operable in the aligned configuration, as shown in FIG. 2. In addition, the switches can be located at different locations on the housing or handle to correspond to convenient locations of the user's fingers when grasping the housing or handle in the different orientation configurations. In one aspect, the switches 46 and 50 can be electrical toggle or pulse switches that turn the motor 38 on and off. In another aspect, the switches 46 and 50 can be variable resistance switches to control the speed of the motor at preset locations, or steps. Additional types of switches, as known in the art can also be used.

In addition, the handheld appliance 10 can include a switch selector 54 (FIG. 3) associated with the housing 14 and operable to engage one switch 46 or 50 and disengage another switch 46 or 50 based on the orientation configuration. Thus, the switch selector 54 can be electrically coupled to the switches 46 and 50, such as between the power source and the switches. The switch selector 54 can toggle back and forth, selectively directing electricity to one of the two switches. The switch selector 54 may be operably disposed to engage the switches 46 and 50 as the two housing sections pivot. Each of the two switches can be selectively deactivated by the switch selector 54 depending on the orientation of the two housing sections with respect to one another. The switch selector can be disposed at the joint such that pivoting of the two housing sections operates the switch selector to selectively allow operation of the switches only in a respective designated interconnected orientation configuration. For example, the switch selector can be a toggle switch or the like coupled to one housing section, such as the handle, while a portion of the other housing section, such as the chuck, engages the toggle switch as the housing sections pivot.

The switch selector is operably disposed to engage the switches as the handle and the chuck pivot. The switch selector can be disposed at a junction between the handle and the chuck, so that twisting the housing engages the switch selector automatically. For example, the switch selector can be a switch mounted on one section of the housing with another section of the housing engaging the switch as the two housing sections pivot with respect to one another. Thus, by pivoting the handle and chuck with respect to each other, a user automatically designates an operable switch for the orientation of the housing that is selected.

It will be appreciated that the switch selector is one example of means for selectively engaging the switches. Alternatively, electrical contacts could be located at the joint to selectively align. The switch selector could also be a magnetic switch operated my magnets located at the joint.

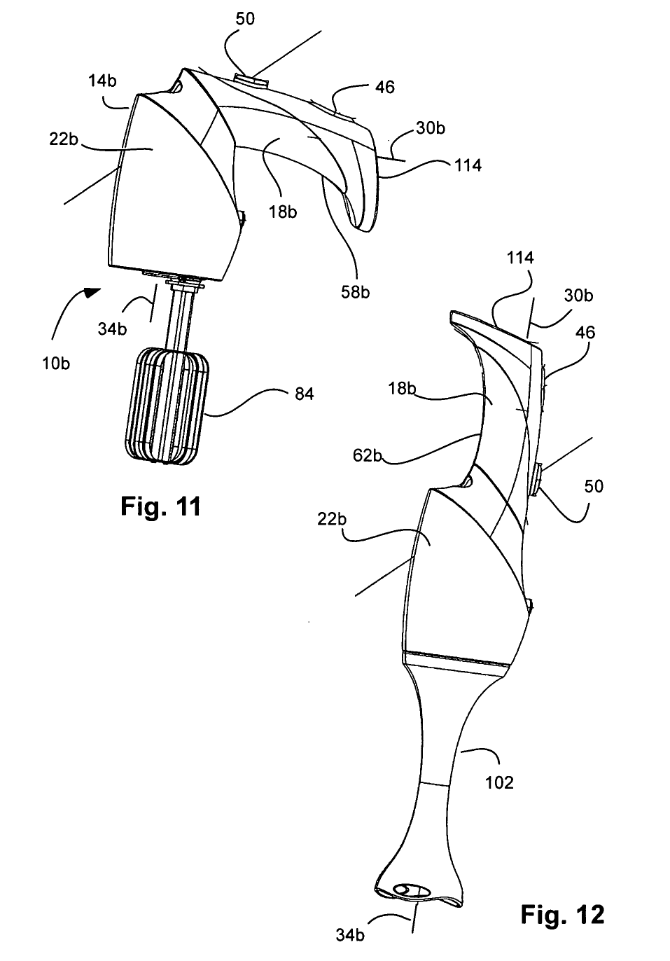

The handle 18 can include two grip portions, such as a horizontal or transverse grip 58 that can be griped by the user in the transverse configuration and a vertical grip 62 that can be griped by the user in the aligned configuration. The transverse grip 58 can be an extension of the handle 18. In this sense, the transverse grip 58 is separate from the vertical grip 62 and can form a loop therewith, as shown in FIGS. 1 and 2. Alternatively, the vertical grip and the transverse grip can be integral with one another, as shown in FIGS. 11 and 12.

The switches 46 and 50 are disposed on opposite sides of the housing 14 or handle 18, as shown in FIGS. 1 and 2. Alternatively, the switches may both be disposed on substantially the same side of the housing as shown in FIGS. 11 and 12. In one aspect, the switches 46 and 50 can both be located on the handle 18. One switch 46 can be disposed on a proximal end of the handle 18, or vertical grip 62, so that it is disposed near a top of the housing in the aligned configuration to be engaged by a user's thumb. Another switch 50 can be disposed intermediate the housing 14, such as on a distal end of the handle 18 or on the horizontal grip 58 to be engaged by a user's thumb in the transverse configuration.

Alternatively, the switches can be disposed on the same side of the handle, as shown in FIGS. 11 and 12.

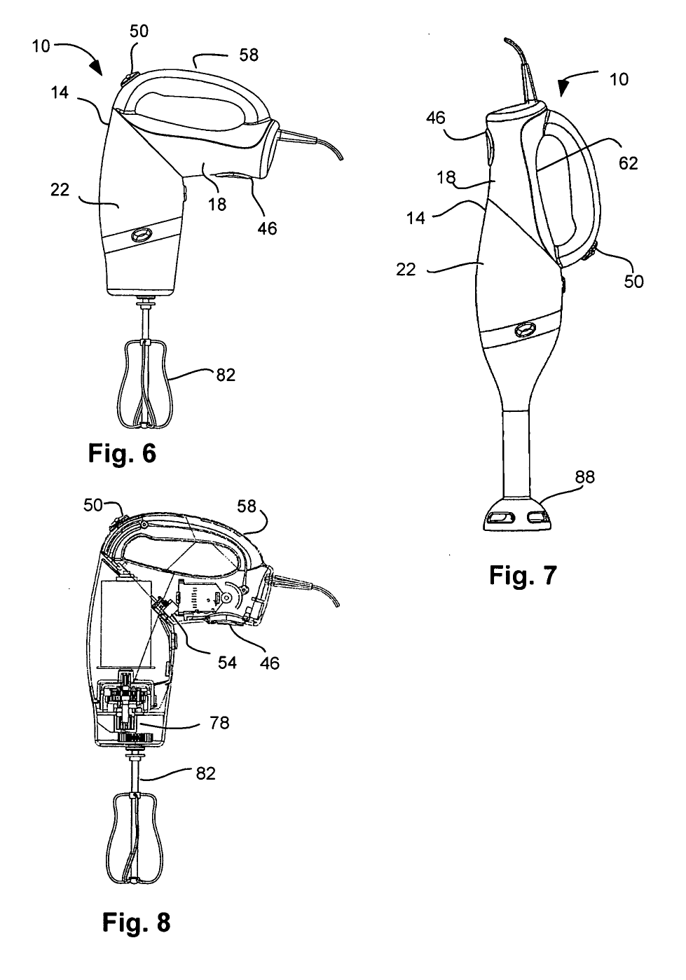

Referring to FIGS. 6-10, the handheld appliance 10 is shown configured as a handheld food preparation appliance with various exemplary rotational elements. The chuck 22 can have distal end or an implement attachment end to receive the rotational element or implement, and which includes the coupling 42 (FIG. 3) from the motor. Thus, the end of the chuck can form a portion of an attachment, socket or connection. A rotational food processing implement can be removably attached to the implement attachment end.

The rotational element can be removably coupled to the implement attachment end of the chuck. The rotational element can be engaged by the motor or coupling 42 when the element is coupled to the implement attachment end of the chuck. The chuck and/or rotational element can include means for retaining or securing the rotational element to the chuck. For example, a C-shaped bias member or spring 66 (FIG. 3) can be disposed in or carried by the chuck 22 to secure the rotational element to the chuck. One or more hooks or barbs 70 (FIGS. 4 and 5) can extend from the bias member and can protrude from the chuck or implement attachment end to engage and retain the rotational element. In addition, one or more buttons 74 can extend from the bias member and can protrude from the chuck so that pushing the buttons 74 causes the hooks or barbs to retract and release the rotational element. The bias nature of the bias member retains the barbs and buttons outward. Alternatively, the C-shaped bias member can be two parts, or two buttons, on opposite sides of the housing.

The rotational element can include a speed optimizing transmission or gear box 78 (FIG. 8) having gears to modify the power from the motor and control the speed of the rotational element.

A variety of food processing implements can be used as the rotational element that can be removably coupled to the implement attachment end of the chuck. For example, the rotational element can be selected from the group consisting of blenders, whisks, beaters, blades and stirring rods. In one embodiment, the rotational element can be a mixer with a beater(s) 82 as shown in FIG. 6. or a pair of beaters 84, as shown in FIG. 11. Alternatively, the beaters could be whisks or the like as known in the art. The beater(s) 82 can be coupled to the transmission or gear box 78. Alternatively, the beaters can be coupled directly to the coupler. In another aspect, the rotational element can be a plunge blender 88, as shown in FIG. 7, with a horizontally rotating blade at the bottom end. In another aspect, the rotational element can be a food processor 92, as shown in FIG. 10. The food processor 92 can include a container or enclosure and one or more rotating blades to chop food in the enclosure. Other implements commonly found on handheld kitchen appliances can also be integrated with the present invention.

Each of the various rotational elements can have a different gear transmission to modify the power from the motor. For example, a stick or plunge blender 88, as shown in FIG. 7, can have no reduction and produce a knife speed of approximately 11,000 rpm. Similarly, a bladed food processor attachment 92, as shown in FIG. 10, can have a 5:1 reduction transmission and produce a knife speed of 2,200 to 1,100 rpm in 5 steps using a variable resistance switch for speed control, as described above. Additionally, a beater 82, as shown in FIG. 6, can have a 10:1 reduction transmission and produce a beater speed of 1,100 to 550 rpm in 5 steps using a variable resistance switch for speed control, as described above. Other gear reducing, speed optimizing transmissions, as known in the art, can be combined with attachable implements.

Referring to FIGS. 6 and 8, the handheld appliance 10 can be configured as a household food preparation appliance, namely a handheld mixer, with the handle 18 and chuck 22 configured in the transverse configuration and a beater 82 or beater attachment coupled to the chuck. In use, the handle 18 can be horizontal with the chuck 22 and beater 82 vertical; and the user can grasp the horizontal grip 58 and engage the switch 50 thereon with the his or her thumb to operate the beaters. The switch selector 54 in the transverse orientation directs power to the switch 50 or electrically couples the switch 50 to the power source. In addition, the switch selector 54 terminates the electrical connection between the other switch 46 and the power source. Thus, the other switch 46 is prevented from operating the motor for safety. As described above, the switch 50 can have variable resistance to also control the speed of the motor.

Referring to FIG. 7, the handheld appliance 10 can be configured as a household food preparation appliance, namely a plunge mixer, with the handle 18 and chuck 22 configured in the aligned configuration and a plunge mixer 88 coupled to the chuck. In use, the handle 18 can be vertical and aligned with the chuck 22 and plunge mixer 88 which are also vertical; and the user can grasp the vertical grip 62 and engage the switch 46 thereon with the his or her thumb to operate the plunge mixer. The switch selector 54 in the aligned orientation directs power to the switch 46 or electrically couples the switch 46 to the power source. In addition, the switch selector 54 terminates the electrical connection between the other switch 50 and the power source. Thus, the other switch 50 is prevented from operating the motor for safety. As described above, the switch 46 can be a push button switch for pulse operation.

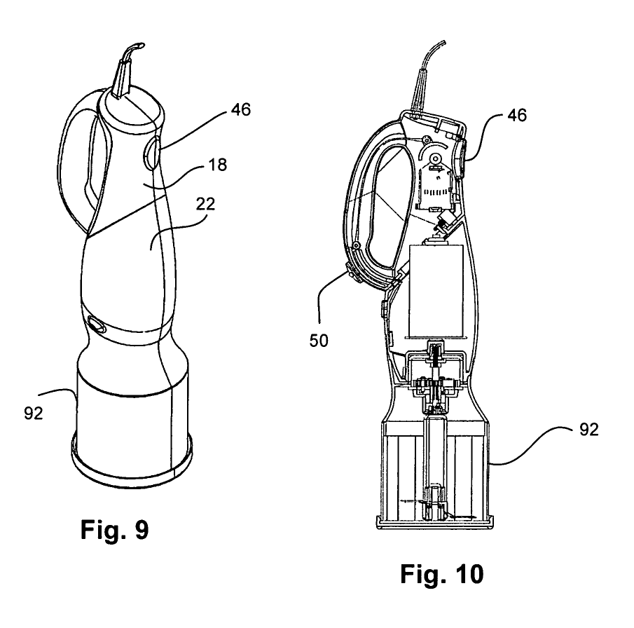

Referring to FIGS. 9 and 10, the handheld appliance 10 can be configured as a household food preparation appliance, namely a food chopper or processor, with the handle 18 and chuck 22 configured in the aligned configuration and a food processor 92 coupled to the chuck. In use, the handle 18 can be vertical and aligned with the chuck 22 and food processor 92 which are also vertical; and the user can grasp the vertical grip 62 and engage the switch 46 thereon with the his or her thumb to operate the plunge mixer. The switch selector 54 in the aligned orientation directs power to the switch 46 or electrically couples the switch 46 to the power source. In addition, the switch selector 54 terminates the electrical connection between the other switch 50 and the power source. Thus, the other switch 50 is prevented from operating the motor for safety.

Referring to FIGS. 11-15, another food preparation appliance 10b is shown that is similar in many respects to that described above, and the above description is incorporated herein by reference. The appliance 10b has a motor 38 and an internal gear box 98 coupled to the motor in the chuck 22b. The chuck 22b or gear box 98 can have a plurality of couplings 42b (FIG. 15) for receiving rotational elements, such as the beaters 84 or the plunge mixer 102 (FIGS. 12 and 14). The plurality of couplings 42b can correspond to different gear locations on the gear box 98, and thus the couplings 42b can have different speeds and torques.

In addition, the handle 18b can have an end 114 distal to the chuck 22b that includes a substantially flat surface that can rest upon a surface (FIG. 13) so that the appliance 10b can be positioned on a surface with the beaters elevated. Additionally, the appliance can have a center of gravity that together with a protrusion on the end 114 of the handle, enables the appliance 10b to stand on the end 114 without falling over, as shown in FIG. 13. The appliance can be self-standing when the handle and chuck are in a transverse orientation configuration.

In addition, the appliance 10b can have a handle 18b that acts as both a transverse grip 58b and a vertical grip 62b. As described in the above embodiment, the transverse grip 58 extends from the handle 18 and is operable to be grasped when the handle 18 and the chuck 22 are in a transverse orientation configuration with respect to each other, as shown in FIG. 6. The transverse grip 58 can extend from the handle 223 so as to form a loop, as shown in FIGS. 6-10. Alternatively, the transverse grip can extend from the handle so as to form a self-terminating extension that does not form a loop. With respect to FIGS. 6-10, a switch 50 can be disposed on the transverse grip 58 of the handle 18 and another switch 46 can be disposed on the vertical grip 62 of the handle 18. Thus, one of the switches 50 is located on the loop defining the transverse grip 58.

In the present embodiment, as shown in FIGS. 11-15, a single grip defining both a transverse and vertical grip 58b and 62b is incorporated directly into the handle 18b and there is no loop or extension of the handle forming a separate transverse grip. The switches 46 and 50 are both located on the same side of handle 18b. When the handle 18b and chuck 22b are in an aligned vertical orientation configuration, a user can hold the appliance by a vertical grip 62b and turn the food preparation appliance on by activating the switch 46 at a distal end of the handle. Similarly, when the handle 18b and chuck 22b are in a transverse orientation configuration with respect to each other, a user can hold the appliance by the transverse grip 58b and turn the appliance on by pressing another switch 50.

The longitudinal axis of the handle and the longitudinal axis of the chuck can form an acute angle, such as 49 degrees. Thus, the handle can swivel 98 degrees between the transverse and aligned configurations.

In addition to the structural elements provided by the present invention and discussed above, the present invention also provides a method of selectively preparing food ingredients. The method includes selecting one of at least two configurations of a food preparation appliance. One configuration is an aligned configuration as shown in FIGS. 2, 7, 9 or 12, in which a longitudinal axis 30 or 30b of a handle 18 or 18b is substantially aligned with a longitudinal axis 34 or 34b of a chuck 22 or 22b. Another configuration is a transverse configuration as shown in FIG. 1, 6 or 11, in which the longitudinal axis 30 or 30b of the handle 18 or 18b is transverse to the longitudinal axis 34 or 34b of the chuck 22 or 22b.

In use, the aligned configuration of the food preparation appliance is convenient in applications wherein the user is preparing food ingredients that are in a deep and/or narrow container such as a tall glass, cup or mug. This configuration can also provide a comfortable, ergonomic hand hold for a user when working with food in small, tippable containers. The transverse orientation configuration can provide a comfortable ergonomic hand hold for a user when working with food in a bowl on a horizontal surface such as a counter top.

The method of the present invention further includes orienting the food preparation appliance in a desired configuration. In one aspect, orienting the food preparation appliance includes engaging one of two switches 46 or 50 and disengaging another switch 46 or 50. The engaging of one switch and disengaging of the other switch can occur substantially simultaneously. The simultaneous engaging of one switch and disengaging of another switch is the results of a switch selector 54 or the like. The switch selector is operably disposed to engage the switches as the handle and the chuck pivot. The switch selector can be disposed at a junction between the handle and the chuck, so that twisting the housing engages the switch selector automatically. Thus, by pivoting the handle and chuck with respect to each other, a user automatically designates an operable switch 46 or 50 for the orientation of the housing that is selected.

The method of the present invention further includes gripping the appliance in a manner associated with the desired configuration. The user generally will grip the handheld food preparation appliance in a manner that is ergonomic and comfortable. The present method also includes positioning a rotational element extending from a chuck of the food preparation appliance into a container (not shown) having ingredients therein, and activating one of two separate switches 46 or 50 associated with the desired configuration of the food preparation appliance. Activating either of the switches operates a motor of the appliance coupled to the rotational element. The user can proceed to process the food ingredients and upon completion of this task, the active switch can then be deactivated to disengage the motor.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A handheld appliance, comprising:
a) a housing including two housing sections pivotally coupled together and having two interconnected orientation configurations with respect to one another;
b) a motor, carried by the housing; and
c) two separate switches associated with the housing and operably coupled to the motor, and each switch operable with a different orientation configuration of the housing sections.

2. A handheld appliance as in claim 1, further comprising a switch selector associated with the housing and operatively coupled to the two separate switches to engage one switch and disengage another switch.

3. A handheld appliance as in claim 2, wherein the switch selector is operably disposed to engage the switches as the two housing sections pivot.

4. A handheld appliance as in claim 1, further comprising:
a joint between the two housing sections about which the housing sections pivot between the two interconnected orientation configurations; and
a switch selector operatively coupled to the two separate switches and disposed at the joint such that pivoting of the two housing sections operates the switch selector to selectively allow operation of the switches only in a respective designated interconnected orientation configuration.

5. A handheld appliance as in claim 1, wherein the switches are disposed on opposite sides of the housing.

6. A handheld appliance as in claim 1, wherein one switch is located at a distal end of a handle housing section and another switch is carried by an extension of one of the housing sections.

7. A handheld food preparation appliance, comprising:
a) a housing including a handle and a chuck pivotally coupled together and having two interconnected orientation configurations with respect to one another, including: i) an aligned configuration in which a longitudinal axis of the handle is substantially aligned with a longitudinal axis of the chuck, and ii) a transverse configuration in which the longitudinal axis of the handle is transverse to the longitudinal axis of the chuck, the handle configured to be gripped and the chuck configured to support at least one rotational element;
b) a motor carried by the housing; and
c) two separate switches associated with the housing and operably coupled to the motor, one switch operable with only the aligned configuration of the handle and the chuck, and another switch operable with only the transverse configuration of the handle and the chuck.

8. A handheld food preparation appliance as in claim 7, further comprising a switch selector associated with the housing and operable to engage one switch and disengage another switch.

9. A handheld food preparation appliance as in claim 8, wherein the switch selector is operably disposed to engage the switches as the handle and the chuck pivot.

10. A handheld food preparation appliance as in claim 7, further comprising:
a joint between the handle and the chuck about which the handle and the chuck pivot between the two interconnected orientation configurations; and
a switch selector operatively coupled to the two separate switches and disposed at the joint such that pivoting of the handle and the chuck operates the switch selector to selectively allow operation of the switches only in a respective designated interconnected orientation configuration.

11. A handheld food preparation appliance as in claim 7, wherein the switches are disposed on opposite sides of the housing.

12. A handheld food preparation appliance as in claim 7, wherein one switch is located at a distal end of the handle and is engaged when the handle and the chuck are linearly aligned with each other, and another switch is carried by a grip associated with the handle and is engaged when the handle and the chuck are in a transverse orientation configuration.

13. A handheld food preparation appliance as in claim 7 wherein the rotational element is selected from the group consisting of blenders, whisks, beaters, blades, and stirring rods.

14. A handheld food preparation appliance as in claim 7, wherein the handle includes a transverse grip and a vertical grip.

15. A handheld food preparation appliance as in claim 14, wherein the transverse grip extends from the handle and is operable to be grasped when the handle and the chuck are in a transverse orientation configuration with respect to each other.

16. A handheld food preparation appliance as in claim 14 wherein a first switch is disposed on the transverse grip of the handle and a second switch is disposed on the vertical grip of the handle.

17. A method of selectively preparing food ingredients comprising:
a) selecting one of at least two configurations of a food preparation appliance, including: i) an aligned configuration in which a longitudinal axis of a handle is substantially aligned with a longitudinal axis of a chuck, and ii) a transverse configuration in which the longitudinal axis of the handle is transverse to the longitudinal axis of the chuck;
b) orienting the food preparation appliance in a desired configuration;
c) gripping the appliance in a manner associated with the desired configuration;
d) positioning a rotational element extending from a chuck of the food preparation appliance into a container having ingredients therein; and
e) activating one of two separate switches associated with the desired configuration of the food preparation appliance to operate a motor of the appliance coupled to the rotational element, including one switch operable only in the aligned configuration and another switch operable only in the transverse orientation.

18. The method of claim 17, wherein orienting the food preparation appliance includes engaging one of two switches and disengaging another switch.

19. The method of claim 18, wherein engaging one switch and disengaging the other switch occurs substantially simultaneously.

20. The method of claim 17, wherein selecting one of at least two configurations includes twisting the handle and the chuck with respect to one another about a joint; and wherein activating one of two separate switches includes operating a switch selector operatively coupled to the two separate switches and disposed at the joint such that twisting of the handle and the chuck operates the switch selector to selectively allow operation of the switches only in a respective designated interconnected orientation configuration.
